(19) United States
(12) Patent Application Publication
(10) Pub. No.: US 2021/0124976 A1
(43) Pub. Date: Apr. 29, 2021

(54) APPARATUS AND METHOD FOR CALCULATING SIMILARITY OF IMAGES

(71) Applicant: SAMSUNG SDS CO., LTD., Seoul (KR)

(72) Inventors: JU-DONG KIM, Seoul (KR); Bong-kyu Hwang, Seoul (KR); Jae-woong Yun, Seoul (KR)

(21) Appl. No.: 16/665,736

(22) Filed: Oct. 28, 2019

(30) Foreign Application Priority Data
Oct. 28, 2019 (KR) 10-2019-0134387

(51) Int. Cl. G06K 9/46; G06K 9/48

(52) U.S. Cl. CPC G06K 9/4642; G06K 9/4609; G06K 9/48

(57) ABSTRACT

An apparatus for calculating a similarity of images according to one embodiment includes a first feature extractor configured to extract an image feature vector from an image, a text region detector configured to detect one or more text object regions included in the image, a second feature extractor configured to extract a text image feature vector from each of the detected text object regions, a third feature extractor configured to recognize text from each of the text object regions and extract a text semantic feature vector from the recognized text, and a concatenator configured to generate a text object feature vector from the text image feature vector and the text semantic feature vector, which are extracted from the same text object region.

### TECHNICAL FIELD

The following description relates to image search, and more specifically, to a technology for effectively searching for an image including a text object.

### BACKGROUND ART

Image search refers to a search through images rather than keywords, and is also referred to as image-to-image. Image search has recently been actively used with the advantage of ease of acquiring information that cannot be found by text-based search using keywords.

In a conventional image search system, only the similarity of query image itself is used for a search. However, an image contains a variety of information as well as features of the image itself. For example, a product image often includes a product image logo, a product name, a model name, and the like. Although in image search, such information is as important element as information of the image itself, the information was not properly used in the conventional image search system. In particular, even though a text object included in the image contains a large amount of information, the text object is not reflected as an effective factor in the image search, which leads to an image search result that does not match the intention of a searcher.

### DISCLOSURE

### Technical Problem

The disclosed embodiments are intended to provide a technical means for improving the performance of image search by utilizing morphological and semantic features of a text object included in an image.

### Technical Solution

In one general aspect, there is provided an apparatus for calculating a similarity of images comprising a first feature extractor configured to extract an image feature vector from an image; a text region detector configured to detect one or more text object regions included in the image; a second feature extractor configured to extract a text image feature vector from each of the detected text object regions; a third feature extractor configured to recognize text from each of the text object regions and extract a text semantic feature vector from the recognized text; and a concatenator configured to generate a text object feature vector from the text image feature vector and the text semantic feature vector, which are extracted from the same text object region.

The concatenator may generate the text object feature vector by concatenating the text image feature vector and the text semantic feature vector.

When a plurality of the text object regions are detected by the text region detector, the concatenator may generate a text object feature matrix that has a text feature vector generated from each text object region as a row.

The apparatus may further comprise a similarity calculator configured to calculate a degree of similarity between a first image and a second image using a first image feature vector and a first text object feature matrix, which are generated from the first image, and a second image feature vector and a second text object feature matrix, which are generated from the second image.

The similarity calculator may calculate the degree of similarity using a first similarity between the first image feature vector and the second image feature vector and a second similarity between the first text object feature matrix and the second text object feature matrix.

The similarity calculator may calculate the first similarity using one of inner product and Euclidean distance between the first image feature vector and the second image feature vector.

The similarity calculator may calculate the second similarity using a maximum value among elements of a matrix resulting from multiplying the first text object feature matrix by a transposed matrix of the second text object feature matrix.

The similarity calculator may calculate the degree of similarity between the first image and the second image by applying a weight to each of the first similarity and the second similarity.

In another general aspect, there is provided a method of calculating a similarity of images comprising extracting an image feature vector from an image; detecting one or more text object regions included in the image; extracting a text image feature vector from each of the detected text object regions; recognizing text from each of the text object regions and extracting a text semantic feature vector from the recognized text; and generating a text object feature vector from the text image feature vector and the text semantic feature vector, which are extracted from the same text object region.

The generating of the text object feature vector may comprise generating the text object feature vector by concatenating the text image feature vector and the text semantic feature vector.

The generating of the text object feature vector may comprise, when a plurality of the text object regions are detected by the text region detection module, generating a text object feature matrix that has a text feature vector generated from each text object region as a row.

The method may further include, after the generating of the text object feature vector, calculating a degree of similarity between a first image and a second image using a first image feature vector and a first text object feature matrix, which are generated from the first image, and a second image feature vector and a second text object feature matrix, which are generated from the second image.

The calculating of the degree of similarity may include calculating the degree of similarity using a first similarity between the first image feature vector and the second image feature vector and a second similarity between the first text object feature matrix and the second text object feature matrix.

The calculating of the degree of similarity may include calculating the first similarity using one of inner product and Euclidean distance between the first image feature vector and the second image feature vector.

The calculating of the degree of similarity may include calculating the second similarity using a maximum value among elements of a matrix resulting from multiplying the first text object feature matrix by a transposed matrix of the second text object feature matrix.

The calculating of the degree of similarity may include calculating the degree of similarity between the first image and the second image by applying a weight to each of the first similarity and the second similarity.

Other features and aspects will be apparent from the following detailed description, the drawings, and the claims.

### Effects of the Invention

According to the disclosed embodiments, morphological and semantic features of a text object included in an image as well as a feature value of the image itself are utilized in image search so that it is possible to improve the performance of image search as compared to the case where only the feature of the image itself is considered.

### BRIEF DESCRIPTION OF THE DRAWINGS

FIG. 1 is a block diagram for describing an apparatus for calculating a similarity of images according to one embodiment.

FIG. 2 is a diagram for describing a process of extracting a feature from a target image in an apparatus for calculating a similarity of images according to one embodiment.

FIG. 3 is a flowchart for describing a method of calculating a similarity of images according to one embodiment.

FIG. 4 is a block diagram illustrating a computing environment including a computing device suitable to be used in exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

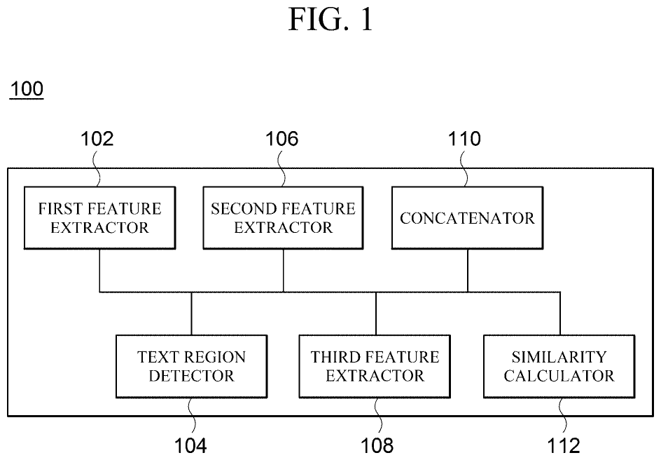

FIG. 1 is a block diagram for describing an apparatus 100 for calculating a similarity of images according to one embodiment. The apparatus 100 for calculating a similarity of images is an apparatus for calculating a degree of similarity between a first image and a second image by taking into account image features of the first image and the second image itself and morphological and semantic features of a text object included in each image. In this case, the morphological feature of the text object may be represented in the form of a vector and includes information on the shape (font, size, and color) of the text. Also, the semantic feature of the text object may be represented in the form of a vector and information containing the meaning of the text may be used to identify the semantic meaning through the vector. It is possible to translate the text object into another language or infer a word similar to the meaning of the text object by using the semantic feature of the text object.

As shown in FIG. 1, the apparatus 100 for calculating a similarity according to one embodiment includes a first feature extractor 102, a text region detector 104, a second feature extractor 106, a third feature extractor 108, a concatenator 110, and a similarity calculator 112.

The first feature extractor 102 extracts an image feature vector from a target image.

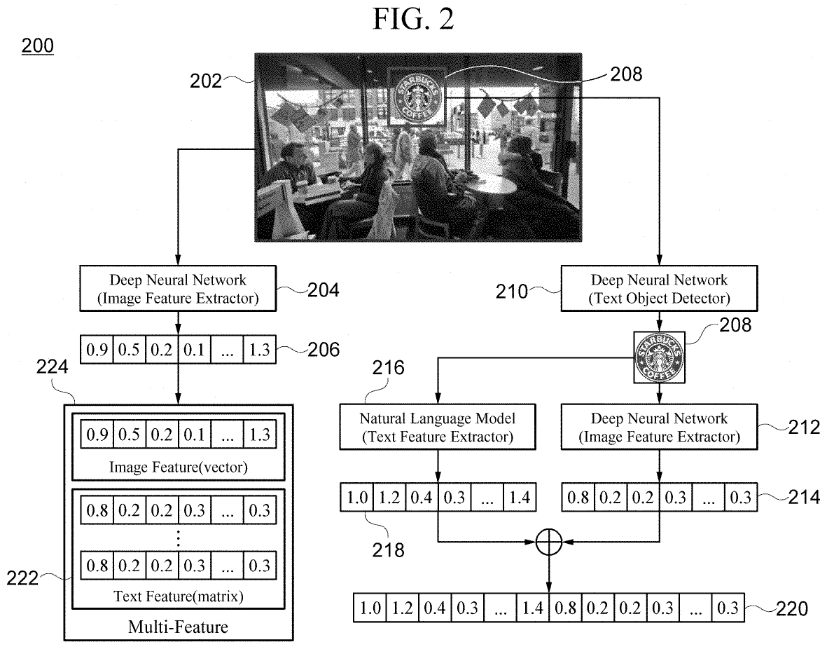

FIG. 2 is a diagram for describing a process of extracting a feature from a target image 202 in an apparatus 100 for calculating a similarity of images according to one embodiment. As shown in FIG. 2, the first feature extractor 102 may extract an image feature vector 206 from the target image 202 using a feature extract layer of a deep neural network 204. The size of the image feature vector 206 to be extracted may be 1×N (N is a natural number greater than or equal to 1). The image feature vector 206 includes information related to the morphological feature of the entire target image 202.

The text region detector 104 detects one or more text object regions 208 included in the target image 202. In one embodiment, the text region detector 104 may recognize a region containing text, such as characters, figures, and the like, in the target image 202 using a deep neural network 210, and detect one or more text object regions 208 by cropping the recognized region. In this case, a structure of the deep neural network 210 for detecting the text object regions may be different from that of the deep neural network 204 for extracting the image feature vector 206 from the target image 202.

In FIG. 2, an example of extracting one text object region 208 from the target image 202 is illustrated. However, disclosed embodiments are not limited to a particular number of text object regions 208, and the text region detector 104 may detect a plurality of text object regions from the same image according to an embodiment.

The second feature extractor 106 extracts a text image feature vector from each of the text object regions 208 detected by the text region detector 104. In one embodiment, the second feature extractor 106 may extract a text image feature vector 214 from each text object region 208 using a feature extract layer of the deep neural network 212. In this case, the size of the extracted text image feature vector 214 may be 1×M1 (M1 is a natural number greater than or equal to 1). The text image feature vector 214 includes information on the morphological features of each text object region 208, for example, font, size, color, and the like of the text included in the corresponding text object region 208.

The third feature extractor 108 recognizes text from each of the text object regions detected by the text region detector 104 and extract a text semantic feature vector 218 from the recognized text. In one example, the third feature extractor 108 may extract the text semantic feature vector 218 by applying the text recognized from the text object region to a natural language processing model 216. In this case, the size of the extracted text semantic feature vector 218 may be 1×M2 (M2 is a natural number greater than or equal to 1). The text semantic feature vector 218 includes information related to the meaning (characters, words, or meaning or content of a paragraph) of text included in the text object region 208.

The concatenator 110 may generate a text object feature vector 220 from the text image feature vector 214 and the text semantic feature vector 218, which are extracted from the same text object region 208. In one embodiment, the concatenator 110 may concatenate the text image feature vector 214 and the text semantic feature vector 216 to generate the text object feature vector 220. For example, in a case where the size of the text image feature vector 214 is 1×M1 and the size of the text semantic feature vector 218 is 1×M2, the size of the text object feature vector 220 may be 1×(M1+M2).

When the text region detector 104 detects a plurality of text object regions, the concatenator 110 may generate a text object feature matrix 222 having, as rows, the text feature vector generated from each of the text object regions.

As such, the image feature vector and the text object feature vector (or text object feature matrix), which are generated from the target image, may constitute a multi-feature 224 of the target image. The similarity calculator 112 calculates a degree of similarity between the first image and the second image by comparing the multi features derived from the first image and the second image.

Specifically, the similarity calculator 112 calculates the degree of similarity between the first image and the second image using a first image feature vector and a first text object feature vector, which are generated from the first image, and a second image feature vector and a second text object feature vector, which are generated from the second image. If a plurality of text object feature vectors are generated from the first image or the second image, the similarity calculator 112 calculates the degree of similarity using a text object feature matrix, rather than the text object feature vector. In the disclosed embodiments, the text object feature vector may be viewed as a special form in which the number of rows of the text object feature matrix is 1. Thus, hereinafter, the similarity calculation process will be described based on the text object feature matrix.

In one embodiment, the similarity calculator 112 may calculate the degree of similarity using a first similarity between the first image feature vector and the second image feature vector and a second similarity between the first text object feature matrix and the second text object feature matrix. The similarity calculator 112 may calculate the degree of similarity between the first image and the second image by applying a weight to the first similarity and the second similarity. For example, when the first similarity is A, the second similarity is B, and the weights of the first similarity and the second similarity are k1 and k2, respectively, the degree of similarity may be calculated by the following Equation 1.

Degree of Similarity=k1*A+k2*B [Equation 1]

In one embodiment, the similarity calculator 112 may calculate the first similarity using one of inner product and Euclidean distance between the first image feature vector and the second image feature vector. For example, when it is assumed that the first image feature vector is Iₐ and the second image feature vector is I_{b}, the first similarity may be calculated by the following Equation 2.

First Similarity=Iₐ·I_{b} [Equation 2]

Also, the similarity calculator 112 may calculate the second similarity using a maximum value among elements of a matrix resulting from multiplying the first text object feature matrix by a transposed matrix of the second text object feature matrix. For example, when the first text object feature matrix is Tₐ and the second text object feature matrix is T_{b}, the resultant matrix may be calculated by the following Equation 3.

Resultant Matrix=Tₐ·T_{b}^{t} [Equation 3]

In a case where the size of the first text object feature matrix Tₐ is n×(M1+M2) and the size of the second text object feature matrix T_{b} is m×(M1+M2), the size of the resultant matrix is (n×m). Then, the similarity calculator 112 may set, as the second similarity, a maximum value among n×m elements constituting the resultant matrix.

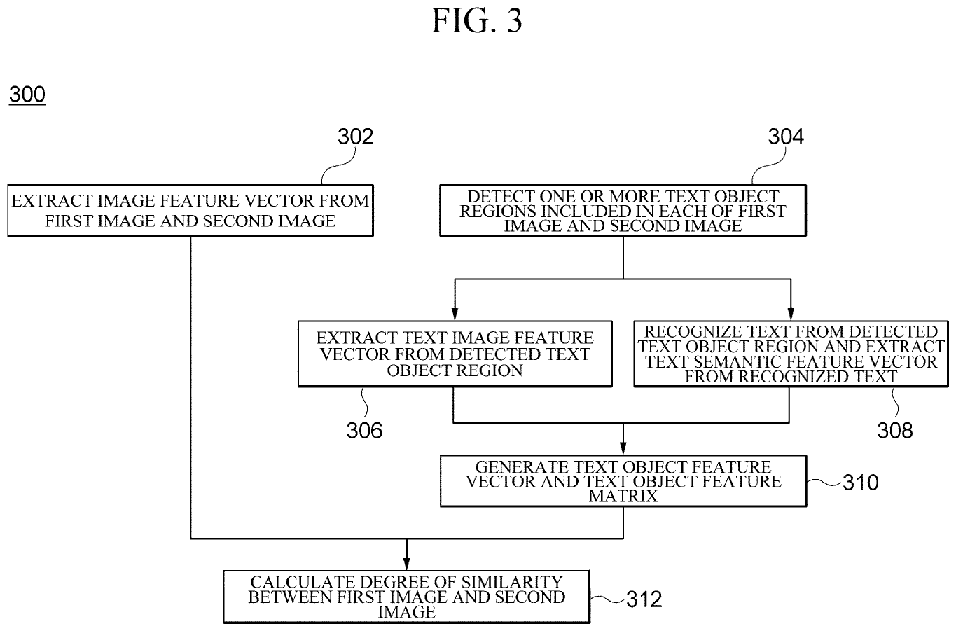

FIG. 3 is a flowchart for describing a method 300 of calculating a similarity of images according to one embodiment. The illustrated flowchart may be performed by a computing device, for example, the above-described apparatus 100 for calculating a similarity of images, which includes one or more processors and a memory in which one or more programs to be executed by the one or more processors are stored. In the illustrated flowchart, the method or process is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

In operation 302, the first feature extractor 102 extracts image feature vectors from a first image and a second image.

In operation 304, the text region detector 104 detects one or more text object regions included in each of the first image and the second image.

In operation 306, the second feature extractor 106 extracts a text image feature vector from each of the detected text object regions.

In operation 308, the third feature extractor 108 recognizes text in each text object region and extracts a text semantic feature vector from the recognized text.

In operation 310, the concatenator 110 generates a text object feature vector from the text image feature vector and the text semantic feature vector, which are extracted from the same text object region. If a plurality of text object regions are extracted from the same image, the concatenator 110 generates a text object feature matrix that has the text feature vector generated from each text object region as a row.

In operation 312, the similarity calculator 112 calculates a degree of similarity between the first image and the second image using a first image feature vector and a first text object feature matrix, which are generated from the first image, and a second image feature vector and a second text object feature matrix, which are generated from the second image.

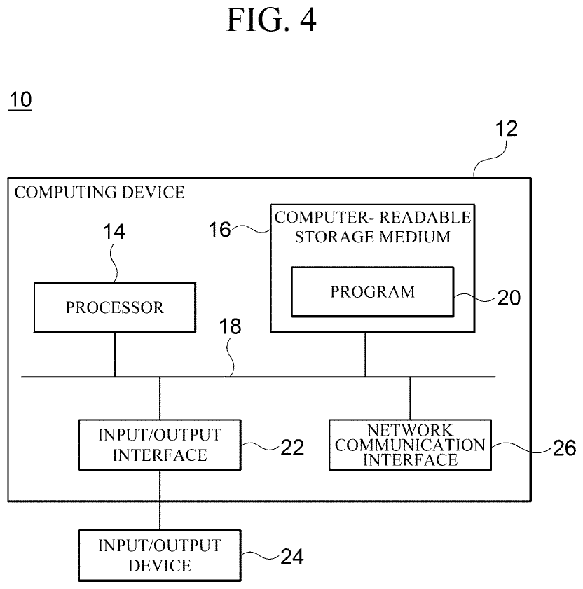

FIG. 4 is a block diagram illustrating a computing environment 10 including a computing device suitable to be used in exemplary embodiments. In the illustrated embodiments, each of the components may have functions and capabilities different from those described hereinafter and additional components may be included in addition to the components described herein.

The illustrated computing environment 10 includes a computing device 12. In one embodiment, the computing device 12 may be an apparatus 100 for calculating a similarity of images according to embodiments of the present disclosure. The computing device 12 12 includes at least one processor 14, a computer-readable storage medium 16, and a communication bus 18. The processor 14 may cause the computing device 12 to operate according to the above-described exemplary embodiment. For example, the processor 14 may execute one or more programs stored in the computer-readable storage medium 16. The one or more programs may include one or more computer executable commands, and the computer executable commands may be configured to, when executed by the processor 14, cause the computing device 12 to perform operations according to an exemplary embodiment.

The computer-readable storage medium 16 is configured to store computer executable commands and program codes, program data and/or information in other suitable forms. The program 20 stored in the computer-readable storage medium 16 may include a set of commands executable by the processor 14. In one embodiment, the computer-readable storage medium 16 may be a memory (volatile memory, such as random access memory (RAM), non-volatile memory, or a combination thereof), one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer-readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24, which is one component constituting the computing device 12, may be included inside the computing device 12 or may be configured as a device separate from the computing device 12 and be connected to the computing device 12.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. An apparatus for calculating a similarity of images, comprising:
a first feature extractor configured to extract an image feature vector from an image;
a text region detector configured to detect one or more text object regions included in the image;
a second feature extractor configured to extract a text image feature vector from each of the detected text object regions;
a third feature extractor configured to recognize text from each of the text object regions and extract a text semantic feature vector from the recognized text; and
a concatenator configured to generate a text object feature vector from the text image feature vector and the text semantic feature vector, which are extracted from the same text object region.

2. The apparatus of claim 1, wherein the concatenator is configured to generate the text object feature vector by concatenating the text image feature vector and the text semantic feature vector.

3. The apparatus of claim 1, wherein when a plurality of the text object regions are detected by the text region detector, the concatenator is configured to generate a text object feature matrix that has a text feature vector generated from each text object region as a row.

4. The apparatus of claim 3, further comprising a similarity calculator configured to calculate a degree of similarity between a first image and a second image using a first image feature vector and a first text object feature matrix, which are generated from the first image, and a second image feature vector and a second text object feature matrix, which are generated from the second image.

5. The apparatus of claim 4, wherein the similarity calculator is configured to calculate the degree of similarity using a first similarity between the first image feature vector and the second image feature vector and a second similarity between the first text object feature matrix and the second text object feature matrix.

6. The apparatus of claim 5, wherein the similarity calculator is configured to calculate the first similarity using one of inner product and Euclidean distance between the first image feature vector and the second image feature vector.

7. The apparatus of claim 5, wherein the similarity calculator is configured to calculate the second similarity using a maximum value among elements of a matrix resulting from multiplying the first text object feature matrix by a transposed matrix of the second text object feature matrix.

8. The apparatus of claim 5, wherein the similarity calculator is configured to calculate the degree of similarity between the first image and the second image by applying a weight to each of the first similarity and the second similarity.

9. A method of calculating a similarity of images, comprising:
extracting an image feature vector from an image;
detecting one or more text object regions included in the image;
extracting a text image feature vector from each of the detected text object regions;
recognizing text from each of the text object regions and extracting a text semantic feature vector from the recognized text; and
generating a text object feature vector from the text image feature vector and the text semantic feature vector, which are extracted from the same text object region.

10. The method of claim 9, wherein the generating of the text object feature vector comprises generating the text object feature vector by concatenating the text image feature vector and the text semantic feature vector.

11. The method of claim 9, wherein the generating of the text object feature vector comprises, when a plurality of the text object regions are detected by the text region detection module, generating a text object feature matrix that has a text feature vector generated from each text object region as a row.

12. The method of claim 11, further comprising, after the generating of the text object feature vector, calculating a degree of similarity between a first image and a second image using a first image feature vector and a first text object feature matrix, which are generated from the first image, and a second image feature vector and a second text object feature matrix, which are generated from the second image.

13. The method of claim 12, wherein the calculating of the degree of similarity comprises calculating the degree of similarity using a first similarity between the first image feature vector and the second image feature vector and a second similarity between the first text object feature matrix and the second text object feature matrix.

14. The method of claim 13, wherein the calculating of the degree of similarity comprises calculating the first similarity using one of inner product and Euclidean distance between the first image feature vector and the second image feature vector.

15. The method of claim 13, wherein the calculating of the degree of similarity comprises calculating the second similarity using a maximum value among elements of a matrix resulting from multiplying the first text object feature matrix by a transposed matrix of the second text object feature matrix.

16. The method of claim 13, wherein the calculating of the degree of similarity comprises calculating the degree of similarity between the first image and the second image by applying a weight to each of the first similarity and the second similarity.
